(19) United States
(12) Patent Application Publication
(10) Pub. No.: US 2013/0063460 A1
(43) Pub. Date: Mar. 14, 2013

(54) VISUAL SHADER DESIGNER

(71) Applicants: Scott Marison, Honolulu, HI (US); Jean-Pierre Duplessis, Kirkland, WA (US); Mohsen Agsen, Honolulu, HI (US); Tito Pagan, Redmond, WA (US)

(72) Inventors: Scott Marison, Honolulu, HI (US); Jean-Pierre Duplessis, Kirkland, WA (US); Mohsen Agsen, Honolulu, HI (US); Tito Pagan, Redmond, WA (US)

(73) Assignee: Microsoft Corporation, Redmond, WA (US)

(21) Appl. No.: 13/227,498

(22) Filed: Sep. 8, 2011

(51) Int. Cl. G09G 5/02

(52) U.S. Cl. 345/582; 345/589

(57) ABSTRACT

An integrated development environment includes a visual shader designer engine that enables a user to create a pixel shader embodied as a directed acyclic graph. The directed acyclic graph contains nodes, where each node is associated with an operation that is used to generate a color characteristic of a final rendered model. The visual shader designer engine displays a rendered image at each node that is the result of the node's operation during development of the directed acyclic graph. An error texture is rendered in a node when an erroneous condition is detected in rendering a node's operations.

### BACKGROUND

Advances in computer graphics have produced sophisticated software to make computer-generated images appear as realistic as possible. In particular, shaders are often used in graphic systems to generate user-designed graphic effects. A shader is a program or code that defines a set of operations to be performed on a geometric object to produce a desired graphic effect. A pixel shader is one type of shader that is used to produce a color for each pixel on each surface of a geometric object. A pixel shader may be used to render effects such as fog, diffusion, motion blur, reflections, texturing, or depth on objects in an image.

A shader performs complex operations and may contain thousands of instructions running potentially hundreds of threads of execution in parallel on a graphics processing unit (GPU). For this reason, the development of a shader may be a daunting task. In particular, testing a shader is problematic since the developer may not have access to the internal registers and data of the various hardware components of the GPU which may be needed to analyze errors in the shader code. Classic debugging techniques, such as embedding print statements in the shader code, may not be practical when the shader involves a large amount of data and executes in multiple parallel threads. Accordingly, the complexity of a shader provides obstacles for developing such programs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Shaders are specialized programs that perform certain mathematical transformations on graphics data. A pixel shader operates on each pixel of an image and applies transformations that produce the color of a pixel. A pixel shader may add transformations to approximate the appearance of wood, marble, or other natural materials and/or to approximate the effects of lighting sources on an object.

An interactive development environment is provided that enables a developer to create a directed acyclic graph representing a pixel shader. The directed acyclic graph contains a number of nodes and edges, where each node contains a code fragment that performs an operation on inputs to the node or generates a value. The interactive development environment contains a visual shader designer engine that executes the operations in each node in a prescribed order and displays the rendered outcome in a render view area in the node. In this manner, the developer is able to visually recognize any erroneous results in the creation of the shader in real time while developing the shader.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a block diagram illustrating an exemplary graphics pipeline.

FIG. 2 illustrates a first exemplary directed acyclic graph representing a pixel shader.

FIG. 3 illustrates a second exemplary directed acyclic graph representing a pixel shader.

FIG. 4 is a block diagram illustrating a system for designing a pixel shader.

FIG. 5 is a flow diagram illustrating a first exemplary method for designing a pixel shader.

FIG. 6 is a flow diagram illustrating a second exemplary method for designing a pixel shader.

FIG. 7 is a flow diagram illustrating a third exemplary method for designing a pixel shader.

FIG. 8 is a block diagram illustrating an operating environment.

FIG. 9 is a block diagram illustrating an exemplary computing device.

### DETAILED DESCRIPTION

Various embodiments are directed to a technology for designing a visual shader having a real-time image rendering capability. In one or more embodiments, the visual shader is a pixel shader that may be developed using an interactive development environment. The interactive development environment may have a shader editor that allows a developer to create a directed acyclic graph representing a pixel shader. The directed acyclic graph has a number of nodes and edges. Each node represents an operation to be applied to a graphic image. An operation may be configured as executable instructions written in a shader programming language. The edges connect one node to another node and form a route so that data output from one node is input into another node. All routes in the directed acyclic graph flow in one direction and end at a terminal node that generates the desired color of a pixel. When the nodes in the graph are aggregated in accordance with the routes, the result is a set of code fragments that form the pixel shader.

The interactive development environment includes a visual shader designer engine that generates a rendered view of the result of each node's operation during the design of the directed acyclic graph. Any errors that result in the development of the directed acyclic graph are displayed in the rendered view area of the node. In this manner, the developer is able to visually recognize erroneous results in the creation of the shader while developing the shader. Attention now turns to a more detailed discussion of the embodiments of the visual shader designer.

Computer systems are used to develop three dimensional (3D) computer graphics that are rendered onto a two dimensional (2D) computer screen or display. Real world objects are viewed in three dimensions and a computer system generates 2D raster images. Images created with 3D computer graphics are used in various applications that range from video games, aircraft flight simulators, to weather forecast models.

The 3D objects in a graphical representation may be created using mathematical models. The mathematical models are composed of geometric points within a coordinate system having an x, y, and z-axis where the axes correspond to width, height, and depth respectively. The location of a geometric point is defined by its x, y, and z coordinates. A 3D object may be represented as a set of coordinate points or vertices. Vertices may be joined to form polygons that define the surface of an object to be rendered and displayed. The 3D objects are created by connecting multiple 2D polygons. A triangle is the most common polygon used to form 3D objects. A mesh is the set of triangles, vertices, and points that define a 3D object.

The graphics data within the polygons may then be operated on by shaders. Shaders are specialized programs that perform certain mathematical transformations on the graphics data. A vertex shader operates on vertices and applies computations on the positions, colors, and texturing coordinates of the vertices. A pixel shader operates on each pixel and applies transformations that produce the color of a pixel. A pixel shader may add transformations to approximate the appearance of wood, marble, or other natural materials and/or to approximate the effects of lighting sources on an object. The output values generated by the pixel shader may be sent to a frame buffer where they are rendered and displayed onto a screen by the GPU.

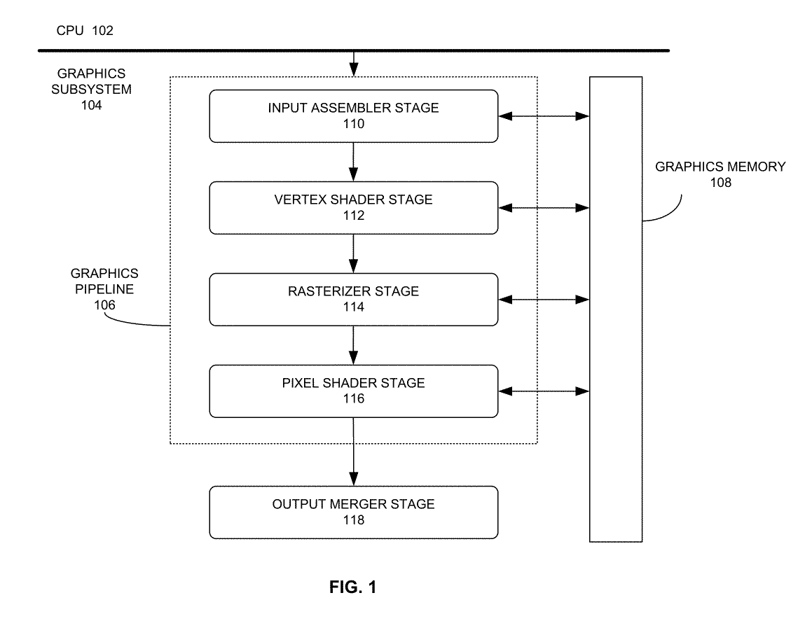

Computer systems typically utilize a graphics pipeline to transform the 3D computer graphics into 2D graphic images. The graphics pipeline includes various stages of processing and may be composed of hardware and/or software components. FIG. 1 illustrates an exemplary graphics subsystem 104 that may have a graphics pipeline 106 and graphics memory 108. The graphics subsystem 104 may be a separate processing unit from the main processor or CPU 102. It should be noted that the graphics subsystem 104 and the graphics pipeline 106 may be representative of some or all of the components of one or more embodiments described herein and that the graphics subsystem 104 and graphics pipeline 106 may include more or less components than that which is described in FIG. 1.

A graphics pipeline 106 may include an input assembler stage 110 that receives input, from an application running on a CPU, representing a graphic image in terms of triangles, vertices, and points. The vertex shader stage 112 receives these inputs and executes a vertex shader which applies transformations of the positions, colors, and texturing coordinates of the vertices. The vertex shader may be a computer program that is executed on a graphics processor unit (GPU). Alternatively, the vertex shader may be implemented in hardware, such as an integrated circuit or the like, or may be implemented as a combination of hardware and software components.

The rasterizer stage 114 is used to convert the vertices, points, and polygons into a raster format containing pixels for the pixel shader. The pixel shader stage 116 executes a pixel shader which applies transformations to produce a color or pixel shader value for each pixel. The pixel shader may be a computer program that is executed on a GPU. Alternatively, the pixel shader may be implemented in hardware, such as an integrated circuit or the like, or may be implemented as a combination of hardware and software components. The output merger stage 118 combines the various outputs, such as pixel shader values, with the rendered target to generate the final rendered image.

A pixel shader operates on pixel fragments to generate a color based on interpolated vertex data as input. The color of a pixel may depend on a surface's material properties, the color of the ambient light, the angle of the surface to the viewpoint, etc. A pixel shader may be represented as a directed acyclic graph (DAG).

A DAG is a directed graph having several nodes and edges and no loops. Each node represents an operation or a value, such a mathematical operation, a color value, an interpolated value, etc. Each edge connects two nodes and forms a path between the connected nodes. A route is formed of several paths and represents a data flow through the graph in a single direction. All routes end at a single terminal node. Each node has at least one input or at least one output. An input may be an appearance value or parameter, such as the color of a light source, texture mapping, etc. An output is the application of the operation defined at a node on the inputs. The final rendered model is represented in the terminal node of the DAG.

Each node in the DAG represents an operation or a value, such a mathematical operation, a color value, an interpolated value, etc. An input may also be the output from another process. The data in a DAG flows in one direction from node to node and terminates at a terminal node. The application of the operations of each node in accordance with the directed routes results in a final color for a pixel that is rendered in the terminal node.

A developer may use an interactive development environment to create a pixel shader. The interactive development environment may contain a graphical interface including icons, buttons, menus, check boxes, and the like representing easy-to-use components for constructing a DAG. The components represent mathematical operations or values that are used to define a node. The visual components are linked together to form one or more routes where each route represents a data flow through the DAG executing the operations specified in each node following the order of the route. The data flow ends at a terminal node that renders the final color of the object. In one or more embodiments, the interactive development environment may be Microsoft's Visual Studio® product.

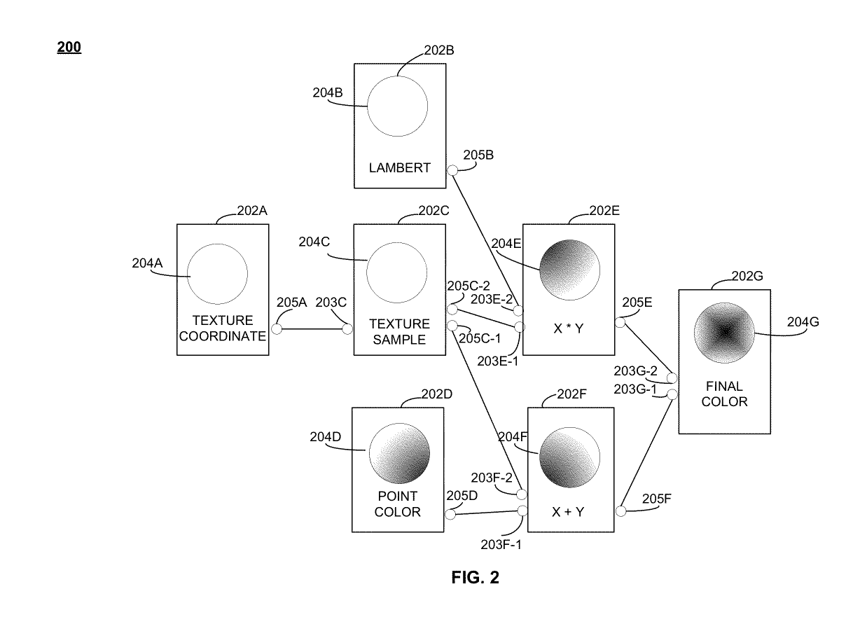

FIG. 2 illustrates a pixel shader embodied as a DAG 200 having been constructed in an interactive development environment using visual components. The DAG 200 represents a pixel shader that shades objects based upon a light source, using a Lambert or diffuse lighting model. The DAG 200 has seven nodes 202A-202G connected to form directed routes that end at a terminal node 202G. Each node, 202A-202G, may have zero or more inputs, 203C, 203E-1, 203E-2, 203F, 203G-1, 203G-2 and zero or more outputs, 205A, 205B, 205C-1, 205C-2, 205D, 205E, and 205F. The outputs of a node may be used as the inputs to other nodes.

Each node performs a particular operation on its inputs and generates a result which is rendered in a render view area 204A-204G. The operation associated with each node may be represented by a code fragment written in a shader language. A shader language is a programming language tailored for programming graphics hardware. There are well-known several shader languages, such as High Level Shader Language (HLSL), Cg, OpenGL (GLSL), and SH, and any of these shader languages may be utilized.

For example, node 202A, contains the texture coordinate of a pixel whose color is being generated, 205C. The texture coordinate represents the index of the pixel, in terms of its x, y coordinates, in a 2D bitmap. Node 202C receives the pixel index, 203C, from node 202A and performs a texture sample operation which reads the color value of the pixel at the location specified by the pixel index in a 2D bitmap. The code fragment associated with node 202C may be written in HLSL as follows:

Texture1.Sample (TexSampler, pixel.uv),

where Texture1.Sample is a function that reads the color value of the pixel from the data structure TexSampler, at the position indicated by pixel.uv.

Upon activation of this texture sample operation, the color value is rendered in the render view area 204C of node 202C and output 205C-1, 205C-2 for use in subsequent operations.

Node 202B represents a Lambert model, which is used to specify the direction of a light source, that is applied to the pixel. The HLSL code fragment associated with node 202B may be as follows:

LambertLighting (tangentLightDir,
float3(0.000000f, 0.000000f, 1.000000f),
AmbientLight.rgb,
MaterialAmbient.rgb,
LightColor[0].rgb,
pixel.diffuse.rgb);
   where LambertLighting is a function that defines the diffuse lighting model. The parameters, tangentLightDir, AmbientLight.rgb, MaterialAmbient.rgb, LightColor[0].rgb, and pixel.diffuse.rgb are used to specify the direction, material, and amount of light used in the model. The value of the Lambert model is output, 205B, for use in a subsequent operation.

Node 202E is a multiply node, that computes a product, x*y, of its two inputs, 203E-1, 203E-2, which will produce the color of a pixel using the intensity of the reflectance of the light specified by the Lambert model. This color is rendered in the render view area 204E of node 202E.

Node 202D represents the current color of the pixel based on the partial transformations made by the vertex shader on the pixel. The current color is rendered in the render view area 204D of node 202D. The point color, 205D, is input to node 202F along with the color value of the pixel color, 205C-1, from node 202C. Node 202F computes the sum, x+y, of its two inputs which generates the resulting color from the combination of the two colors, which is shown in the render view area 204F of node 202F and output, 205F, to node 202G.

Node 202G receives the outputs, 205E, 205F, from nodes 202E, 202F and generates the final color as the combination of the colors of its inputs. The final color is rendered in the render view area 204G of node 202G. As shown in FIG. 2, the render view area in each node provides a developer with a real-time view of the result of each operation in combination with other operations. In this manner, errors may be detected more readily and remedied quickly.

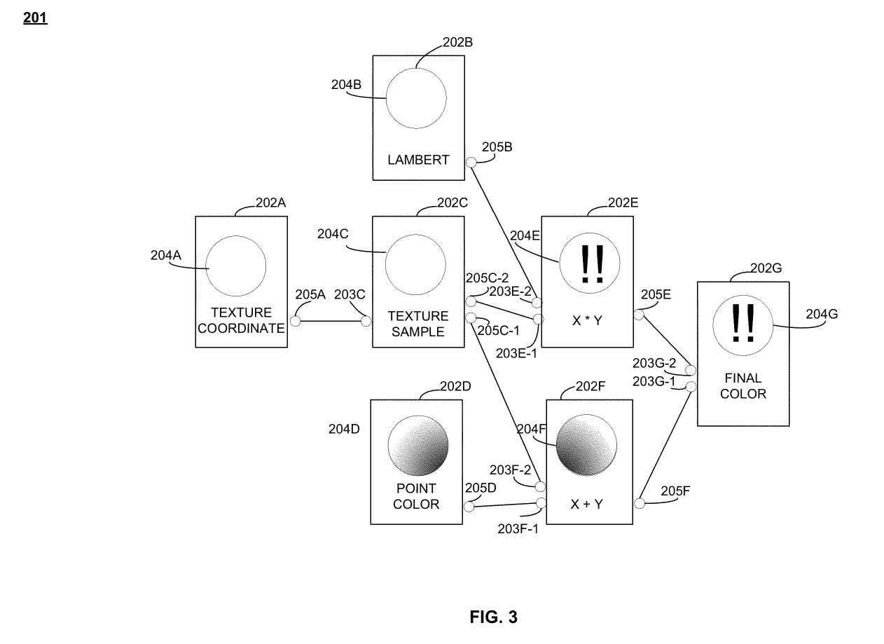

FIG. 3 illustrates a pixel shader embodied as a DAG visually displaying an error texture that indicates an erroneous condition or construction of the sequence of nodes. In particular, an error shader may render the error texture in the render view area of nodes 202E, 202G to alert the developer to an error. For example, the Lambert model may have produced invalid values resulting in an erroneous condition. Since the output of node 202E is input to node 202G, the render view areas in both of these nodes, 204E, 204G, displays an error texture. A developer may recognize the affected nodes more readily due to the error texture thereby leading the developer to the source of the error during development. Attention now turns to a description of a system for developing a pixel shader in real time.

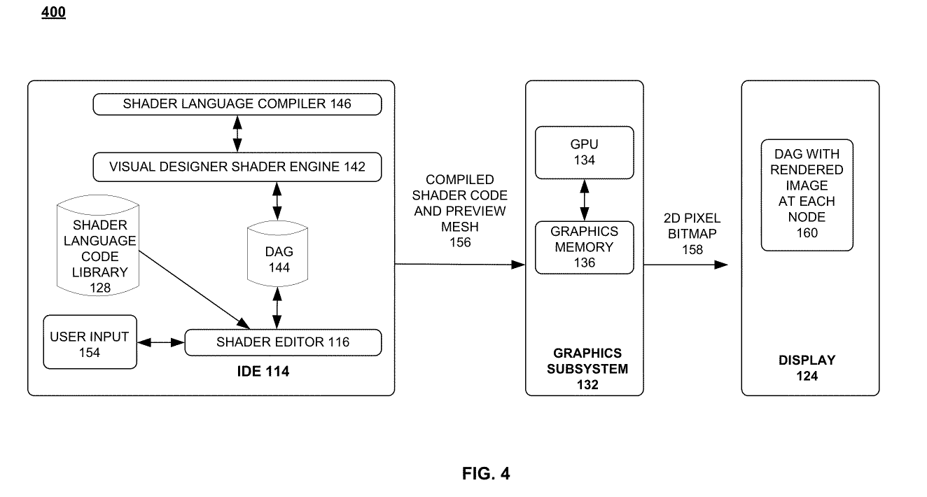

FIG. 4 illustrates an exemplary system 400 for designing a pixel shader. Although the system 400 shown in FIG. 4 has a limited number of components in a certain configuration, it may be appreciated that the system 400 may include more or less components in alternate configurations for a given implementation.

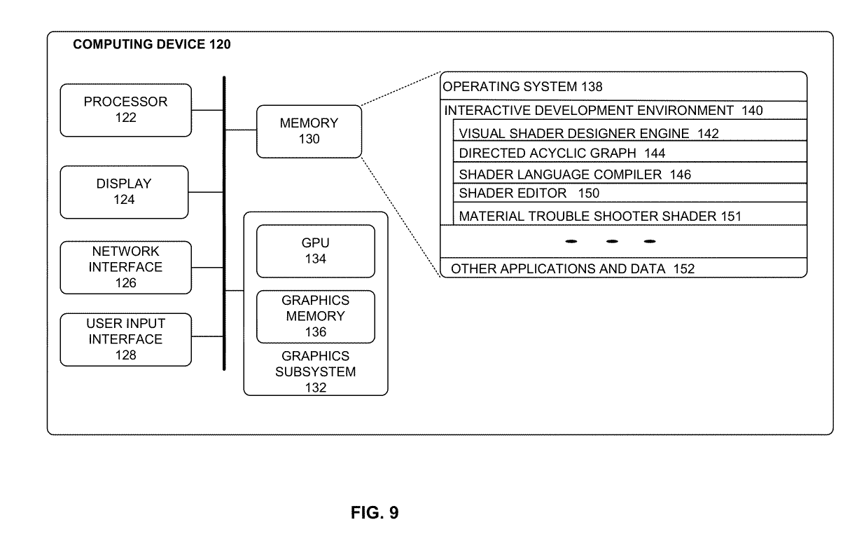

The system 400 may include an interactive development environment (IDE) 114 coupled to a graphics subsystem 132, which may be coupled to a display 124. The IDE 114, graphics subsystem 132, and display 124 may be components of a single electronic device or may be distributed amongst multiple electronic devices. The graphics subsystem 132 may contain a GPU 134 and a graphics memory 136. The graphics subsystem 132 and display 124 are well known components of a computer-implemented system and may be described in more detail below with respect to FIG. 9.

The IDE 114 may include a shader editor 116, a shader language code library 128, a visual designer shader engine 142, and a shader language compiler 146. The shader editor 116 may be used by a developer to generate a shader through user input 154. The shader language code library 128 contains code fragments containing programmable instructions that are contained in a node in the DAG 144. The visual designer shader engine 142 generates a rendered image for each node in the DAG 144. A shader language compiler 146 may be used to compile the code fragments in each node of the DAG 144 into an executable format for execution on a GPU 134. The output of the IDE may be the compiled shader code and a preview mesh which may be transmitted to the graphics subsystem 132. The graphics subsystem 132 executes the compiled shader code and transforms the preview mesh into a 2D pixel bitmap 158. The 2D pixel bitmap 158 is rendered onto the render view area of a node 160 of the DAG 144 in a display 124.

Attention now turns to a description of embodiments of exemplary methods used to construct a pixel shader using a visual shader designer engine. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. The methods can be implemented using one or more hardware elements and/or software elements of the described embodiments or alternative embodiments as desired for a given set of design and performance constraints. For example, the methods may be implemented as logic (e.g., computer program instructions) for execution by a logic device (e.g., a general-purpose or specific-purpose computer).

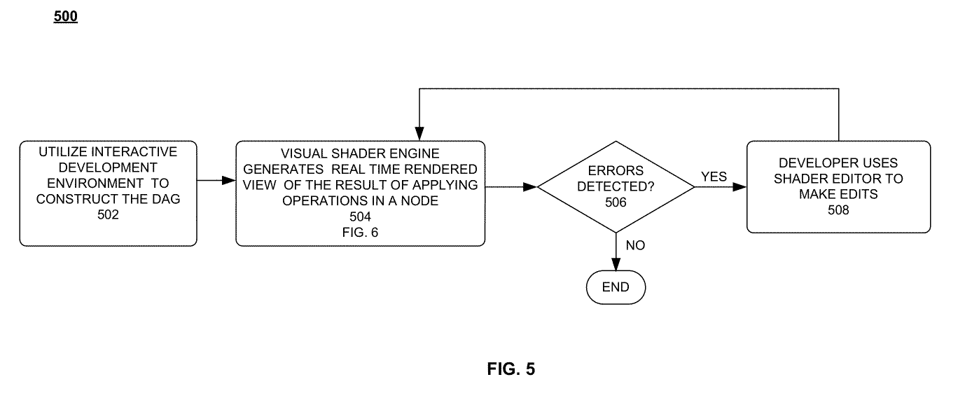

FIG. 5 illustrates a flow diagram of an exemplary method for designing a pixel shader. It should be noted that the method 500 may be representative of some or all of the operations executed by one or more embodiments described herein and that the method can include more or less operations than that which is described in FIG. 5.

An interactive development environment 114 may be a software application having a collection of tools, such as a shader editor 116 and a virtual shader designer engine 142. The shader editor 116 may include a graphical user interface having visual components, such as menus, buttons, icons, etc., that enable a developer to develop a directed acyclic graph representing a pixel shader, such as the directed acyclic graph shown in FIG. 1 (block 502). Upon completion of the directed acyclic graph, the developer may utilize the visual shader designer engine 142 to produce a visualization of the operation in each node in the directed acyclic graph (block 504). If an error is detected (block 506—yes), then the developer may use the shader editor 116 to make edits to the directed acyclic graph (block 508). The developer may then re-engage the visual shader designer engine 142 again to obtain a visualization of the results (block 504). Otherwise, if no errors are detected (block 506—no), then the process ends.

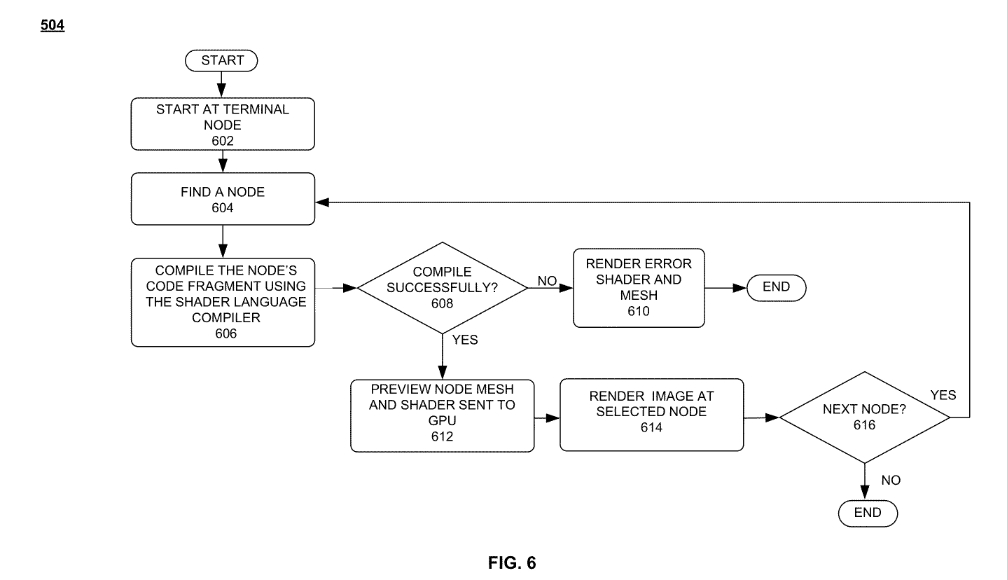

FIG. 6 illustrates an exemplary method of the visual shader designer engine 142 in generating a rendered view in each node of the directed acyclic graph. The visual shader designer engine 142 obtains a directed acyclic graph and traverses each node in the graph in a prescribed manner starting at the terminal node (block 602). The visual shader designer engine 142 locates the terminal node, which acts as a root node for the traversal. From the terminal node, the directed acyclic graph is recursively traversed in post order to select a node to process. The leaf nodes are selected first and then the nodes that receive their input, and so forth until the terminal node is reached.

The visual shader designer engine 142 traverses the DAG to find a node to process (block 604). The code fragments aggregated at the node are compiled using the shader language compiler 146 (block 606). If the node's code fragments do not compile successfully (block 608—no), then an error texture may be rendered in the nodes' render view area (block 610) and the process ends. An error texture is a unique texture that indicates an error. In one or more embodiments, a material trouble shooter shader 151 may be used to render the error texture.

Otherwise, if the code fragments compiled successfully (block 608—yes), the node's preview mesh and compiled code fragments are sent to the GPU (block 612) where the resulting image is rendered in the node's render view area (block 614). If there is another node to process, (block 616—yes), then the process repeats for the next node. Otherwise, when the current node being processed is the terminal node, then the process is completed and ends (block 616—no).

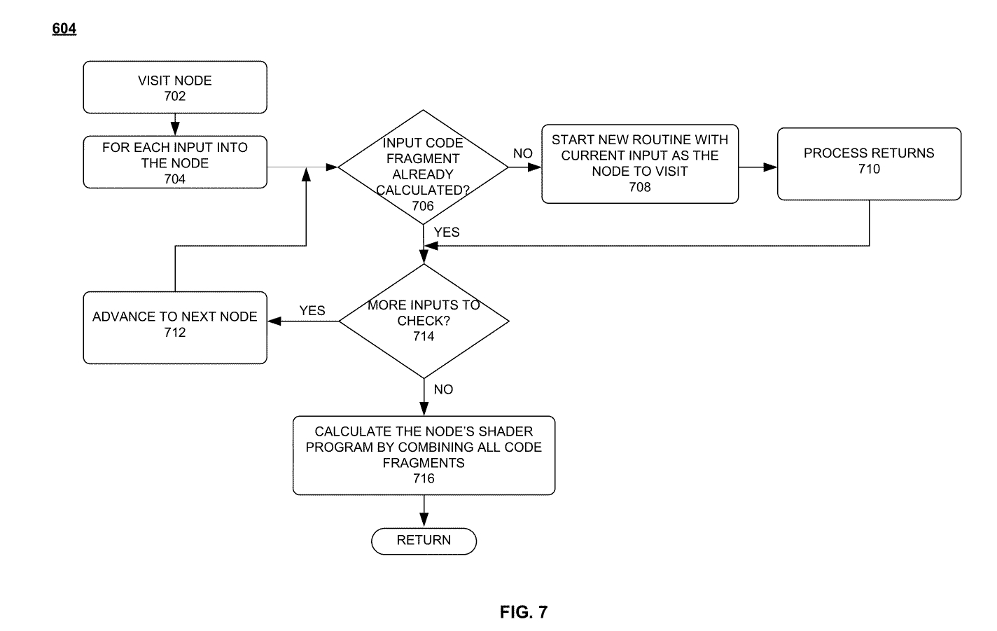

FIG. 7 illustrates an exemplary method for traversing the DAG in a prescribed manner to calculate the code fragments of each node. The calculation of the code fragment in a node requires aggregating the code fragments associated with the node and the code fragments associated with all the inputs to the node. As such, the calculation starts with the leaf nodes in the DAG and works through the internal nodes in the DAG until the terminal node is reached. At the terminal node, the calculation will have aggregated all the code fragments in the DAG into a shader program.

The process visits a given node (block 702). The input nodes to the given node are then processed one at a time (block 704). The process checks if the code fragment of the input node has been calculated (block 706). The calculation of a node is the aggregation of the node's code fragment with each of the code fragments of each of its inputs. If the code fragment of the node's input has not been calculated (block 706—no), then the process calls itself recursively with the current input node as the node to visit (block 708). When the process returns (block 710), it then checks if there are more input nodes to check (block 714) and proceeds accordingly.

If the input node's code fragment has already been calculated (block 706—yes), then the process proceeds to check if the node has additional input nodes (block 714). If there are more input nodes (block 714—yes), then the process advances to the next node (block 712). If there are no further input nodes to check (block 714), then the current node needs to be calculated. This is done by aggregating the node's code fragment with the code fragments of each input node (block 716). The process returns to FIG. 6, block 604, and then proceeds to compile the node's code fragment as noted above.

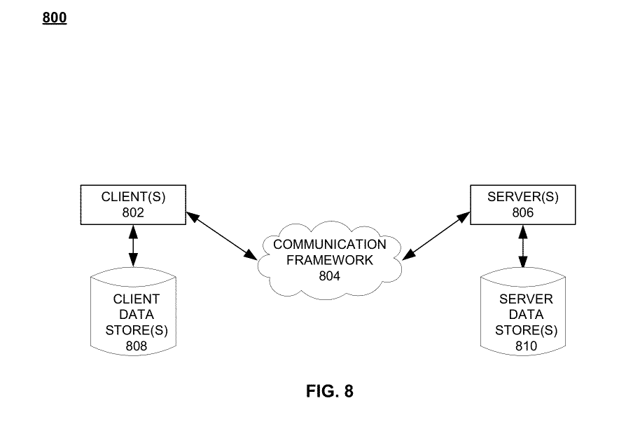

Attention now turns to a discussion of an exemplary operating environment for the visual shader designer. Referring now to FIG. 8, there is shown a schematic block diagram of an exemplary operating environment 800. It should be noted that the operating environment 800 is exemplary and is not intended to suggest any limitation as to the functionality of the embodiments. The embodiments may be applied to an operating environment having one or more client(s) 802 in communication through a communications framework 804 with one or more server(s) 806. The operating environment may be configured in a network environment or distributed environment having remote or local storage devices. Additionally, the operating environment may be configured as a stand-alone computing device having access to remote or local storage devices.

The client(s) 802 and the server(s) 806 may be any type of electronic device capable of executing programmable instructions such as, without limitation, a mobile device, a personal digital assistant, a mobile computing device, a smart phone, a cellular telephone, a handheld computer, a server, a server array or server farm, a web server, a network server, an Internet server, a work station, a mini-computer, a mainframe computer, a supercomputer, a network appliance, a web appliance, a distributed computing system, multiprocessor systems, or combination thereof.

The communications framework 804 may be any type of communications link capable of facilitating communications between the client(s) 802 and the server(s) 806, utilizing any type of communications protocol and in any configuration, such as without limitation, a wired network, wireless network, or combination thereof. The communications framework 404 may be a local area network (LAN), wide area network (WAN), intranet or the Internet operating in accordance with an appropriate communications protocol.

In one or more embodiments, the operating environment may be implemented as a computer-implemented system having multiple components, programs, procedures, modules. As used herein these terms are intended to refer to a computer-related entity, comprising either hardware, a combination of hardware and software, or software. For example, a component may be implemented as a process running on a processor, a hard disk drive, multiple storage drives (of optical and/or magnetic storage medium), an object, an executable, a thread of execution, a program, and/or a computing device. By way of illustration, both an application running on a server and the server may be a component. One or more components may reside within a process and/or thread of execution, and a component may be localized on one computer and/or distributed between two or more computers as desired for a given implementation. The embodiments are not limited in this manner.

FIG. 9 illustrates a block diagram of an exemplary computing device 120 implementing the visual shader designer. The computing device 120 may have a processor 122, a display 124, a network interface 126, a user input interface 128, a graphics subsystem 132, and a memory 130. The processor 122 may be any commercially available processor and may include dual microprocessors and multi-processor architectures. The display 124 may be any visual display unit. The network interface 126 facilitates wired or wireless communications between the computing device 120 and a communications framework. The user input interface 128 facilitates communications between the computing device 120 and input devices, such as a keyboard, mouse, etc. The graphics subsystem 132 is a specialized computing unit for generating graphic data for display. The graphics subsystem 132 may be implemented as a graphics card, specialized graphic circuitry, and the like. The graphics subsystem 132 may include a graphic processing unit (GPU) 134 and a graphics memory 136.

The memory 130 may be any computer-readable storage media that may store executable procedures, applications, and data. It may be any type of memory device (e.g., random access memory, read-only memory, etc.), magnetic storage, volatile storage, non-volatile storage, optical storage, DVD, CD, floppy disk drive, and the like. The computer-readable media does not pertain to propagated signals, such as modulated data signals transmitted through a carrier wave. The memory 130 may also include one or more external storage devices or remotely located storage devices. The memory may 130 contain instructions and data as follows:
an operating system 138;
a interactive development environment 140 including a visual shader designer engine 142, a directed acyclic graph 144, a shader language compiler 146, a shader editor 150, and a material trouble shooter shader 151; and
various other applications and data 152.

It should be noted that although the visual shader designer engine has been described as a component to an interactive development environment, the embodiments are not limited to this configuration of the visual shader designer engine. The visual shader designer engine may be a stand-alone application, combined with another software application, or used in any other configuration as desired.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Various embodiments may be implemented using hardware elements, software elements, or a combination of both. Examples of hardware elements may include devices, components, processors, microprocessors, circuits, circuit elements, integrated circuits, application specific integrated circuits, programmable logic devices, digital signal processors, field programmable gate arrays, memory units, logic gates and so forth. Examples of software elements may include software components, programs, applications, computer programs, application programs, system programs, machine programs, operating system software, middleware, firmware, software modules, routines, subroutines, functions, methods, procedures, software interfaces, application program interfaces, instruction sets, computing code, code segments, and any combination thereof. Determining whether an embodiment is implemented using hardware elements and/or software elements may vary in accordance with any number of factors, such as desired computational rate, power levels, bandwidth, computing time, load balance, memory resources, data bus speeds and other design or performance constraints, as desired for a given implementation.

Some embodiments may comprise a storage medium to store instructions or logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software components, such as programs, procedures, module, applications, code segments, program stacks, middleware, firmware, methods, routines, and so on. In an embodiment, for example, a computer-readable storage medium may store executable computer program instructions that, when executed by a processor, cause the processor to perform methods and/or operations in accordance with the described embodiments. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

What is claimed:

1. A computer-implemented method, comprising:
representing a first shader as a directed graph having a plurality of nodes, each node associated with an operation or value configured to produce a graphic effect; and
generating a rendered view in each node, the rendered view illustrating application of an operation associated with a node.

2. The computer-implemented method of claim 1, the generating step further comprising:
for each node, producing a first set of programmable instructions that implement an operation associated with a node, the first set of programmable instructions including programmable instructions associated with each input to the node and programmable instructions associated with a node.

3. The computer-implemented method of claim 2, the generating step further comprising:
transforming the first set of programmable instructions into a second set of programmable instructions, the second set of programmable instructions generating the rendered view.

4. The computer-implemented method of claim 2, wherein the second set of programmable instructions is executed on a graphics processing unit.

5. The computer-implemented method of claim 2, the generating step further comprising:
compiling the first set of programmable instructions into a second set of programmable instructions;
detecting an error in compilation of the first set of programmable instructions; and
executing a second shader to render an error texture in a node associated with the first set of programmable instructions.

6. The computer-implemented method of claim 3, further comprising:
executing the second set of programmable instructions;
detecting an error in execution of the second set of programmable instructions; and
executing a second shader to render an error texture in a node associated with the second set of programmable instructions.

7. The computer-implemented method of claim 3, wherein the first set of programmable instructions is generated on a processor that is different from the graphics processing unit.

8. The computer-implemented method of claim 1, wherein the rendered view is associated with a color characteristic.

9. The computer-implemented method of claim 1, wherein the first shader is a pixel shader.

10. A computer-readable storage medium storing thereon processor-executable instructions, comprising:
an editor and a visual shader designer engine, the editor having processor-executable instructions that when executed generate a directed acyclic graph, the directed acyclic graph having a plurality of nodes, each node containing a first set of executable instructions associated with performing an operation on a graphic object, the visual shader designer engine having processor-executable instructions that when executed traverses each node in the directed acyclic graph in a prescribed order to generate a rendered graphic image, in each node.

11. The computer-readable storage medium of claim 10, further comprising a shader language compiler having processor-executable instructions that when executed transforms the first set of execution instructions into a final set of executable instructions, the final set of executable instructions executed by a graphics processor and generating the rendered graphic image in each node.

12. The computer-readable storage medium of claim 10, the directed acyclic graph having a terminal node, the terminal node being a node at which all routes in the directed acyclic graph terminate, the terminal node associated with a complete set of executable instructions forming a pixel shader.

13. The computer-readable storage medium of claim 10, further comprising a second shader for rendering an error texture in a node affected by an erroneous condition.

14. The computer-readable storage medium of claim 10, further comprising a shader language code library containing code fragments associated with operations performed in a node, the editor having processor-executable instructions to generate shader language code in each node.

15. The computer-readable storage medium of claim 10, the visual shader designer engine having processor-executable instructions that when executed aggregates the first set of executable instructions in a node to include executable instructions associated with inputs to a node and executable instructions associated with a node.

16. A system, comprising:
a first processor and a first memory, the first memory having a visual shader designer engine, the visual shader designer engine having instructions that when executed on the first processor generates a final set of instructions for each node in a directed acyclic graph using operations and inputs associated with a node; and
a graphics processor that executes the final set of instructions received from the visual shader designer engine and renders a graphic image resulting from execution of the final set of instructions in each node.

17. The system of claim 16, wherein each node in the directed acyclic graph has a rendered view area for displaying the rendered graphic image resulting from execution of the final set of instructions associated with a node.

18. The system of claim 17, wherein the final set of instructions associated with a node include instructions associated with a node and instructions associated with inputs to a node.

19. The system of claim 16, wherein the directed acyclic graph has a terminal node, the terminal node associated with an aggregated set of instructions formed from combining the final instructions of each node, the aggregated set of instructions representing a pixel shader.

20. The system of claim 16, the first memory having a second shader, the second shader having instructions that when executed on the graphics processor renders a error texture in each node affected by an erroneous condition resulting from execution of the final set of instructions associated with a node.
